(19) United States
(12) Patent Application Publication
(10) Pub. No.: US 2013/0035853 A1
(43) Pub. Date: Feb. 7, 2013

(54) Prominence-Based Generation and Rendering of Map Features

(71) Applicants: Bryce Stout, Seattle, WA (US); Brian Brewington, Fort Collins, CO (US); Jonah Jones, Sydney (AU); Christos Savvopoulos, Zurich (CH)

(72) Inventors: Bryce Stout, Seattle, WA (US); Brian Brewington, Fort Collins, CO (US); Jonah Jones, Sydney (AU); Christos Savvopoulos, Zurich (CH)

(73) Assignee: Google Inc., Mountain View, CA (US)

(21) Appl. No.: 13/197,570

(22) Filed: Aug. 3, 2011

(51) Int. Cl. G06T 17/05; G06T 11/00; G01C 21/00

(52) U.S. Cl. 701/438; 345/419; 345/619; 701/454

(57) ABSTRACT

A capability for prominence-based feature generation and rendering for digital maps is provided. More specifically, embodiments relate to rendering map features such as buildings or landmarks in different rendering styles based on signals for how important a particular feature is to a search context. A search context may be, for example and without limitation, a general view of the map or a user-initiated search request for a particular point of interest or driving directions between different points of interest on the map. For example, the different rendering styles may include, but are not limited to, two-dimensional (2D) footprints, two-and-a-half-dimensional (2.5D) extruded polygons, as will be described further below, and full three-dimensional (3D) models. Furthermore, the style could include color and/or visual texture.

### BACKGROUND

1. Field

Embodiments relate generally to the field of mapping systems, particularly to displaying imagery in mapping systems.

2. Background

Computerized mapping systems enable users to view and navigate geospatial data in an interactive digital environment. Such an interactive digital environment may be provided, for example, by a web-based mapping service accessible to a user via a web browser. Tie mapping system may also enable the user to search and view various points of interest on a digital map. Each point of interest may be geo-coded to a particular location on the map. Accordingly, information for a point of interest stored by the mapping system may include data associated with the location. Examples of such data include, but are not limited to, a name or type of business at the location (e.g., gas station, hotel, restaurant, retail store, or other business), a name or type of public place of interest at the location (e.g., public school, post office, park, train station, airport, etc.), a name or address of a building or landmark at the location, or other relevant data associated with the location on the map. Further, the mapping system may enable the user to request driving directions to a particular location or point of interest, which may be displayed with the map using, for example, a graphical overlay of a route traced between two or more points on the map.

Various map features (e.g., buildings, landmarks, etc.) associated with a geographic area containing point(s) of interest requested by the user are displayed on the map, rendered, for example, in a window of the user's browser. However, similar types of features (e.g., buildings located on a city block) are generally rendered uniformly in conventional mapping systems. As a result, users may have difficulty distinguishing map features that may be more pertinent to their needs and search criteria when using such conventional systems.

### BRIEF SUMMARY

Embodiments relate to prominence-based generation and rendering of map features. In an embodiment, a search context is determined for a user of a map based on user input. The search context may correspond, for example, to a geographic region of interest on the map, where the geographic region of interest includes a plurality of map features. A prominence score can be assigned to each of these map features based on the determined search context for the user. The prominence score of each map feature represents the map feature's relevance with respect to the search context. A graphical representation of each map feature is then generated based on the feature's assigned prominence score. The graphical representation of each map feature is to be rendered for the geographic region of interest on the map in accordance with a rendering style selected from a plurality of rendering styles. A particular rendering style may be selected based on the respective prominence score assigned to each of the map features. The generated graphical representation of each of the map features may be stored in a memory for later access and rendering, for example, to a display coupled to a client device of the user.

Embodiments may be implemented using hardware, firmware, software, or a combination thereof and may be implemented in one or more computer systems or other processing systems.

Further embodiments, features, and advantages of the present invention, as well as the structure and operation of the various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the information contained herein.

### BRIEF DESCRIPTION OF THE DRAWINGS/FIGURES

Embodiments are described, by way of example only, with reference to the accompanying drawings. In the drawings, like reference numbers may indicate identical or functionally similar elements. The drawing in which an element first appears is typically indicated by the leftmost digit or digits in the corresponding reference number.

FIG. 1 is a diagram of an exemplary distributed system suitable for practicing an embodiment.

FIG. 2 is an exemplary system for prominence-based generation of map features, according to an embodiment.

FIGS. 3A-3B illustrate example browser displays for a web-based mapping service, according to an embodiment.

FIG. 4 is a process flowchart of an exemplary method for prominence-based generation of map features, according to an embodiment.

FIG. 5 is a diagram of an example computer system in which embodiments can be implemented.

The accompanying drawings, which are incorporated herein and form part of the specification, illustrate the embodiments of present invention and, together with the description, further serve to explain the principles of the invention and to enable a person skilled in the relevant art(s) to make and use the invention.

### DETAILED DESCRIPTION

### Introduction

A capability for prominence-based feature generation and rendering for digital maps is provided. More specifically, embodiments relate to rendering map features such as buildings or landmarks in different rendering styles based on signals for how important a particular feature is to a search context. A search context may be, for example and without limitation, a general view of the map or a user-initiated search request for a particular point of interest or driving directions between different points of interest on the map. For example, the different rendering styles may include, but are not limited to, two-dimensional (2D) footprints, two-and-a-half-dimensional (2.5D) extruded polygons, as will be described further below, and full three-dimensional (3D) models. Furthermore, the style could include rendering scale, color, and/or visual texture. Accordingly, stylistic elements such as contrast and transparency may be adjusted based on the significance of a particular map feature with respect to the search context. For example, non-emphasized features and areas on the map may appear “grayed out” and/or in low-contrast when the map is displayed or presented to the user on a display device, as will be described in further detail below.

While maps generally provide useful abstractions of geographic regions, such a capability enables maps to be even more useful by rendering certain features that may be of particular interest to a user in greater detail, while leaving other features less fully specified. As will be described in further detail below, map features including, but not limited to, buildings corresponding to a geographic area of interest can be assigned prominence scores based on the feature's significance or relevance with respect to a search context associated with the map. Each map feature can then be rendered in a particular style based on the feature's assigned prominence score.

In an example, when a user performs a search for a neighborhood in a city, relevant buildings or landmarks may be assigned relatively higher prominence scores than other map features. Accordingly, such buildings or landmarks in the neighborhood of interest can be emphasized on the map when viewed by the user. For example, such features may be rendered as full 3D models while other buildings or map features may be rendered in less detail, for example, as 2.5D extruded polygons, or even as 2D footprints, as noted above. Further, a map feature having a relatively higher prominence score may be rendered according to a larger rendering scale than its actual scale on the map. For example, a famous landmark may be rendered at one or more zoom levels to appear disproportionately greater than its actual size relative to the map (e.g., a giant Eiffel tower on a map of Paris).

In another example, the user may search for the locations of points of interest on the map. If, for example, the user were to enter a general search request for “Pizza,” buildings containing pizza restaurants within a geographic region or area of interest to the user can be rendered in 3D, while leaving all other buildings in the region as flat 2D footprints. The geographic region of interest may be based on, for example, a current location associated with the user on the map.

In yet another example, the user may search for driving directions to a particular physical address of a business or residence. In addition to turn-by-turn driving directions, a highlighted route to the destination may be displayed, for example, as an overlay on the map. To further assist the user in navigating to the destination, buildings where the user needs to turn and various points of interest (e.g., landmarks) located along the route can be rendered more prominently than other non-prominent features. Furthermore, while a map feature such as a landmark (e.g., a sports stadium) having a high prominence score in a navigation context may be located at a relatively substantial distance from the route or the user's current position, such a feature may be rendered to appear very visually prominent to the user. For example, driving directions may be provided so as to indicate to the user that such a map feature will be visible at some distance from the route, e.g., “after you turn right, you should see the XYZ Stadium about a mile away.”

It is noted the above-described examples are presented for illustrative purposes, and embodiments are not intended to be limited thereto. Moreover, while the present invention is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to effect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The terms “map feature” and “feature” are used interchangeably herein to refer broadly and inclusively to any natural or artificial structure or geospatial entity, including geographic features that can be represented on a map in digital form. Examples of such map features include, but are not limited to, buildings, historical or natural landmarks, roads, bridges, rail routes, parks, universities, hospitals, shopping centers, and airports. Further, such map features may be associated with a place of business, physical address, road and intersection, geographic coordinates (e.g., latitude and longitude coordinates), and other places (e.g., cities, towns, states, provinces, states and continents). As will be described in further detail below, a user may request a search for such a place and the corresponding search results may include one or more map features associated with the place. The map feature(s) may be graphically represented on a digital map (e.g., using visual place marker(s) or other type(s) of visual overlay) and displayed to the user via a display device.

As indicated above, the term “two-and-a-half dimensional” (or simply “2.5D”) is used herein to refer broadly and inclusively to any graphical representation or model of an object having a set of extruded polygons (e.g., right prisms) in geometrical space. Such a two-and-a-half-dimensional model can comprise a set of extruded polygons. The extruded polygons may be, for example, right prisms. In addition, each extruded polygon may have multiple shells and holes that define the polygon's volume in space according to its position relative to a reference plane. The shells may correspond to, for example, outer loops of each polygon, and the holes may correspond to, for example, inner loops of each polygon. Such a volume is further defined by a base height from which extrusion begins, and an extrusion distance.

### System Overview

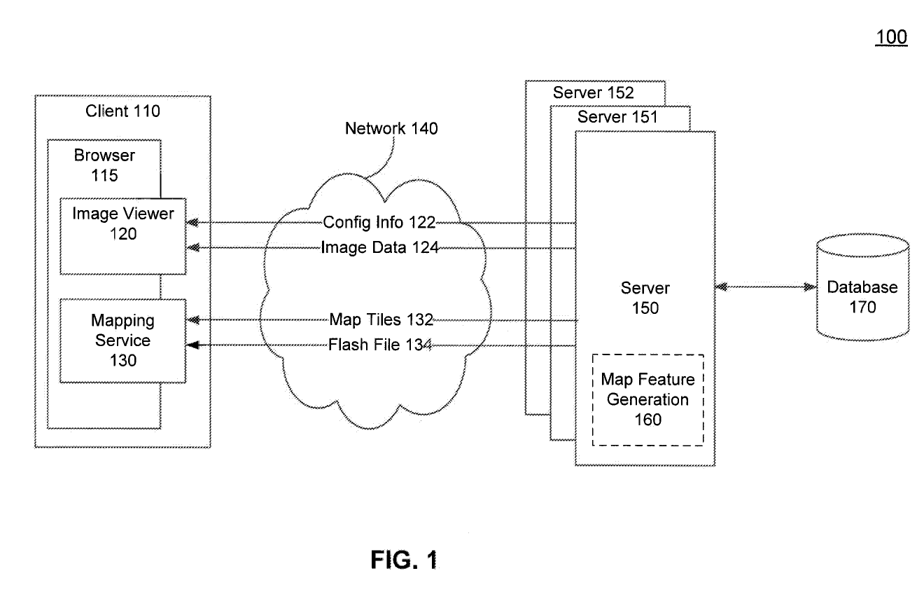

FIG. 1 is a diagram of an exemplary distributed system 100 suitable for practicing an embodiment. In the example shown in FIG. 1, system 100 includes a client 110, a browser 115, a map image viewer 120, configuration information 122, image data 124, a mapping service 130, map tiles 132, a flash file 134, a network 140, servers 150, 151, and 152, a functionality for map feature generation 160, and a database 170.

Client 110 communicates with one or more servers 150-152, for example, across network 140. Although only servers 150-152 are shown, additional servers may be used as necessary. Network 140 can be any network or combination of networks that can carry data communication. Such network can include, but is not limited to, a local area network, medium area network, and/or wide area network such as the Internet. Client 110 can be a general-purpose computer with a processor, local memory, a display (e.g., LCD, LED, CRT monitor), and one or more input devices (e.g., a keyboard, mouse, or touchscreen display). Alternatively, client 110 can be a specialized computing device such as, for example, a tablet computer or other mobile device.

Furthermore, client 110 may include a GPS receiver that can optionally be used to record location-based information corresponding to the device (and its user) over time. For example, client 110 may be a dedicated GPS device or other mobile device including an integrated GPS receiver and storage for recording GPS data captured by the GPS receiver. It is noted that due to privacy reasons associated with tracking a user's location information, users of such a device generally would be required to “opt-in” or voluntarily choose to enable location-tracking features (e.g., by selecting an appropriate option in a device settings panel provided by client 110) before the device will track or record any user location information.

Server(s) 150 can be implemented using any general-purpose computer capable of serving data to client 110. In an embodiment, server(s) 150 are communicatively coupled to database 170. Database 170 may store any type of data (e.g., image data 124) accessible by server(s) 150. Although only database 170 is shown, additional databases may be used as necessary.

Client 110 executes map image viewer 120 (or simply “image viewer 120”), the operation of which is further described herein. Image viewer 120 may be implemented on any type of computing device. Such a computing device can include, but is not limited to, a personal computer, mobile device such as a mobile phone, workstation, embedded system, game console, television, set-top box, or any other computing device. Further, such a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components.

As illustrated by FIG. 1, image viewer 120 requests configuration information 122 from server(s) 150. As discussed in further detail herein, the configuration information includes meta-information about an image to be loaded, including information on links within the image to other images. In an embodiment, the configuration information is presented in a form such as the Extensible Markup Language (XML). Image viewer 120 retrieves image data 124 for the image, for example, in the form of images or in the form of image tiles. In another embodiment, image data 124 includes the configuration information in the relevant file format.

The configuration information 122 and image data 124 can be used by image viewer 120 to generate a visual representation of the image (e.g., a digital map having a plurality of map features) and any additional user interface elements, as further described herein. In addition, such a visual representation and additional user interface elements may be presented to a user on a client display (not shown) communicatively coupled to client 110. Client display can be any type of electronic display for viewing images or can be any type of rendering device adapted to view three-dimensional images. As a user interacts with a user input device (e.g., mouse or touch-screen display) to manipulate the visual representation of the image, image viewer 120 updates the visual representation and proceeds to download additional configuration information and images as needed.

In an embodiment, images retrieved and presented by image viewer 120 are graphical representations or models of various real-world objects associated with a geographical region. Further, such graphical representations may be generated at various levels of detail. For example, 2.5D or 3D representations of buildings from a city block may be generated based on images of a major city taken by satellite at various angles. In a further embodiment, images retrieved and presented by image viewer 120 include, but are not limited to, the generated 2D footprint, 2.5D, and 3D graphical models that can be rendered on the client display. For example, the generated graphical representations or models may be stored in database 170 or other data repository or database accessible to server(s) 150 over network 140.

In an embodiment, image viewer 120 can be implemented together as a standalone application, or it can be executed within a browser 115. For example, browser 115 may be any Internet-connected browser capable of displaying a digital map and various types of map imagery corresponding to geographic locations as represented by the map (e.g., within an image viewer such as image viewer 120). Image viewer 120, for example, can be executed as a script within browser 115, as a plug-in within browser 115, integrated with browser 115, or as a program that executes within a browser plug-in, such as the ADOBE FLASH plug-in from Adobe Systems Inc. of San Jose, Calif.

In an embodiment, image viewer 120 is integrated with mapping service 130. As will be described in further detail below, mapping service 130 may be any mapping service capable of providing interactive digital maps and associated features to a user. For example, mapping service 130 may be embedded in browser 115 and integrated with a map image viewer 120. Further, mapping service 130 may enable the user to utilize various features as provided by mapping service 130.

In an example, the user may be able to search and view various geographic locations of interest by using various user interface controls provided by mapping service 130 (e.g., within image viewer 120 and/or browser 115). In another example, the user may be able to send a request for directions between various locations of interest to mapping service 130. The directions may be displayed within image viewer 120 as, for example, an overlay on a digital map. Further, mapping service 130 may allow the user to select a mode of travel and accordingly, provide customized driving directions for the particular mode selected by the user (e.g., driving directions for travel by car, walking directions for travel by foot, directions for travel using a bicycle, etc.). Additional features and characteristics of such a web-based mapping service would be apparent to a person skilled in the relevant art given this description.

In an embodiment, mapping service 130 is integrated with image viewer 120. Mapping service 130 displays a visual representation of a map, e.g., as a viewport into a grid of map tiles. Mapping service 130 can be implemented using any combination of markup and scripting elements, e.g., using HTML and Javascript. As the viewport is moved, mapping service 130 requests additional map tiles 132 from server(s) 150, assuming the requested map tiles have not already been cached in local cache memory. Notably, the server(s) that serve map tiles 132 can be the same or different server(s) from the server(s) that serve image data 124 or the other data involved herein.

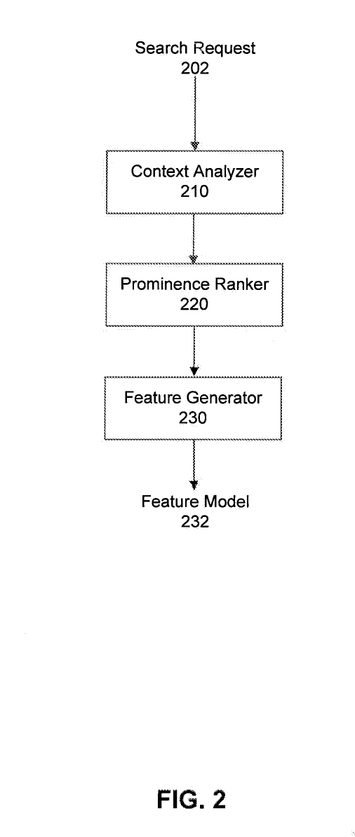

In an embodiment, mapping service 130 and image viewer 120 can be adapted to render graphical representations/models representing various map features (e.g., buildings) using a client display coupled to client 110, as described above. For example, the graphical models for various map features to be rendered by image viewer 120 may be included in image data 124. As will be described in further detail below with respect to FIG. 2, map feature generation 160 may be configured to generate such graphical representations of map features based on the prominence score assigned to each feature, as described above, according to an embodiment. For example, the representations of map features may be generated at varying levels of detail depending on each feature's prominence score, which may then be used to specify the particular rendering style in which each feature is rendered.

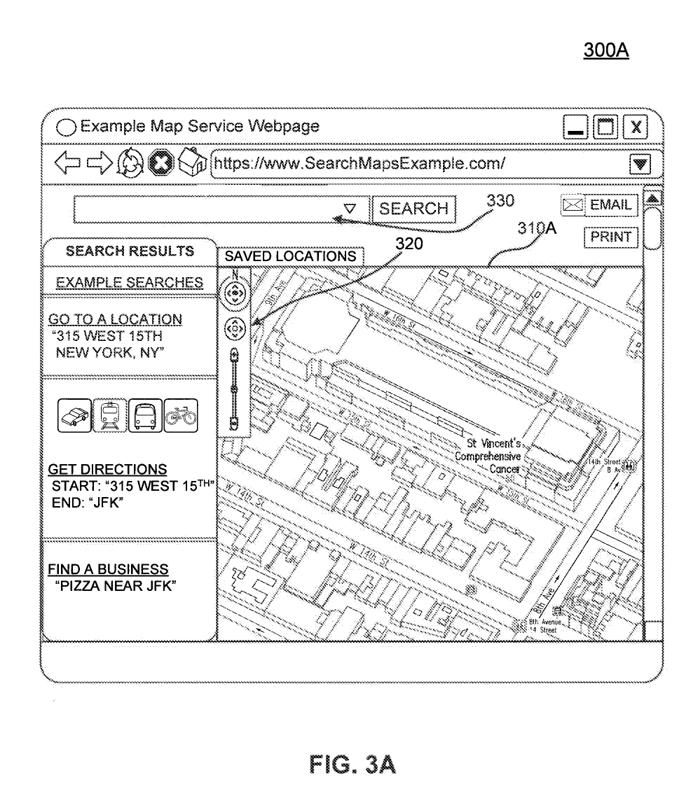

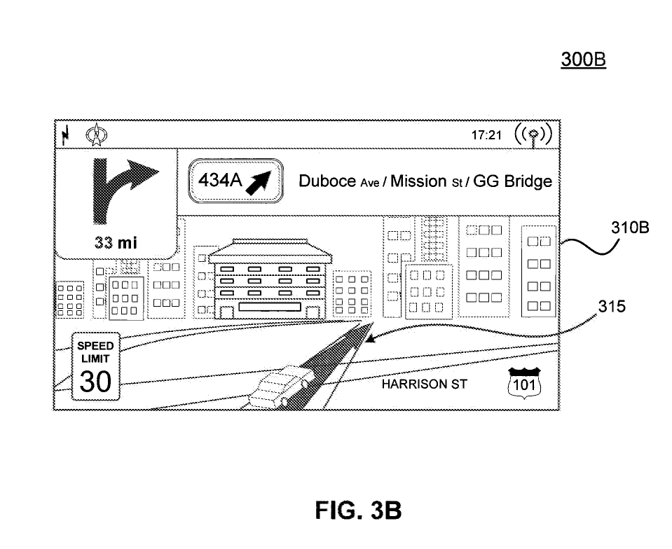

In an embodiment, mapping service 130 can request that browser 115 proceed to download a flash file 134 for image viewer 120 from server(s) 150 and to instantiate any plug-in necessary to run flash file 134. Flash file 134 may be any software program or other form of executable content. Image viewer 120 executes and operates as described above. In addition, configuration information 122 and even image data 124, including automatically generated models, can be retrieved by mapping service 130 and passed to image viewer 120. Image viewer 120 and mapping service 130 communicate so as to coordinate the operation of the user interface elements, to allow the user to interact with either image viewer 120 or mapping service 130, and to have the change in location or orientation reflected in both. Additional description of a web-based mapping service and integrated image viewer such as those illustrated in FIG. 1 will be described further below with respect to the example browser displays 300A and 300B of FIGS. 3A and 3B, respectively. However, embodiments are not intended to be limited thereto.

As described above, embodiments can be operated according to a client-server configuration. However, it is noted that embodiments are not limited thereto and may be configured to operate solely at the client, with configuration information 122, image data 124, and map tiles 132 available at the client. For example, configuration information 122, image data 124, and map tiles 132 may be stored in a storage medium accessible to client 110, such as a CD-ROM or hard drive, for example. Accordingly, no communication with server(s) 150 would be needed.

### Prominence-Based Generation and Rendering of Map Features

FIG. 2 is an exemplary system 200 for prominence-based generation of map features, according to an embodiment. In the example shown in FIG. 2, system 200 includes a context analyzer 210, a prominence ranker 220, and a feature generator 230. For ease of explanation, system 200 will be described in the context of system 100 of FIG. 1, but embodiments are not intended to be limited thereto. For example, system 200 may be implemented as a component of system 100 of FIG. 1, discussed above, according to an embodiment. Accordingly, context analyzer 210, prominence ranker 220, and feature generator 230 may be implemented as one or more components of map feature generation 160 of server(s) 150, as shown in FIG. 1 and described above. Although only context analyzer 210, prominence ranker 220, and feature generator 230 are shown in FIG. 2, it would be apparent to a person skilled in the relevant art given this description that system 200 may include additional components, modules, and/or sub-components as necessary. In an embodiment, context analyzer 210, prominence ranker 220, and feature generator 230 may be communicatively coupled via, for example, an internal data bus of a computing device (e.g., server 150, as described above).

In an embodiment, context analyzer 210 is configured to determine a search context for a user of a digital map based on a request initiated by the user. As previously noted, a search context can be any general view (e.g., a zoomed-in view) of the map or a search request for a particular point of interest (e.g., search for a business name) or driving directions between different points of interest on the map. In an embodiment, the search context corresponds to a geographic region of interest to the user on the map. The geographic region of interest may have a plurality of map features including, for example and without limitation, roads, buildings, monuments, landmarks, and any other man-made or naturally formed structures.

For example, in reference to system 100 of FIG. 1, the digital map may be displayed to the user via a display coupled to client 110, as described above. As such, the map may be presented in an image viewer 120 of browser 115, as described above. Further, various user interface controls may be provided by mapping service 120 enabling the user to perform various actions in association with the map. Such actions may include, but are not limited to, manipulating views of the map, entering search requests for various geographic locations or points of interest, and requests for directions (e.g., by car or other mode of travel, as noted above) between different points of interest as represented on the map. For example, such actions may be initiated by the user based on the user's manipulation of the one or more user interface controls via, for example, a user input device coupled to client 110. By initiating such actions, the user may also initiate various requests, which may be received and processed by map feature generation 160. As will be described in further detail below with respect to the example browser display 300A shown in FIG. 3A, requests may be initiated by the user based on user input (e.g, via search field 330), and may be sent automatically from mapping service 130 of client 110 to map feature generation 160 of server(s) 150 over network 140, as described above.

In an embodiment, context analyzer 210 is configured to determine a current view of the map to be displayed to the user based on a request initiated by the user. As described above, the user may select a view of the map as it is displayed in image viewer 120 by manipulating a user interface control provided to the user via image viewer 120 or other user control portion of the user's browser. For example, such a view may be associated with a particular level of zoom for viewing map data using image viewer 120. Further, each selectable level of zoom may be associated with a level of detail in which the map data is to be rendered within image viewer 120. In an embodiment, the current view of the map as determined by context analyzer 210 specifies a geographic region of interest to the user on the map.

In an example, context analyzer 210 may be configured to receive a user search request for a particular geographic point of interest on the map. For example, the geographic point of interest may be located within a particular geographic region of interest on the map. Further, the geographic region of interest may be specified by the current view of the map as selected by the user. A person skilled in the relevant art given this description would appreciate that the point of interest may not necessarily be located within a current view or geographic region of interest of the map.

In another example, context analyzer 210 may be configured to receive a request for directions between different geographic points of interest or locations on the map. In an embodiment, context analyzer 210 determines a route of travel between a current geographic location associated with the user and a destination on the map in response to the user's request for directions. For example, such a destination may correspond to a particular point of interest to the user (e.g., a particular business name or physical address), and the directions may be for driving directions if the user chooses to travel by car. The route of travel may be visually presented to the user as a highlighted path and rendered as a graphical overlay on the map as displayed in an image viewer (e.g., image viewer 120). Additionally, a textual list of turn-by-turn directions may also be displayed (e.g., in a portion of a window in browser 115).

In this latter example pertaining to a user request for directions, context analyzer 210 may perform a search for one or more geographic points of interest on the map along a determined route of travel between different geographic location points on the map (e.g., between the user's current location and the destination). Each geographic point of interest along the route may be associated with one or more map features to be rendered as the user travels along the route. In a further example, referring back to system 100 of FIG. 1, client 110 may be a mobile device having a GPS and mapping service 130 and image viewer 120 may be implemented on such mobile device for real-time navigation purposes.

As will be described in further detail below, graphical representations corresponding to selected map features along the determined path/route can be rendered in association with the map (e.g., via mapping service 130 and integrated image viewer 120) based on a prominence score associated with each of the map features to be represented for a particular geographic point of interest or current view of the map.

In an embodiment, prominence ranker 220 is configured to assign such a prominence score or ranking to each map feature in the plurality of map features to be rendered for a geographic region of interest based on the search context (e.g., driving directions, a search for a point of interest, or a general view of the map) as determined by context analyzer 210. In an embodiment, prominence ranker 220 assigns the prominence score to each map feature based on that map feature's relevance with respect to the search context. Accordingly, a map feature having a higher prominence score relative to other map features may be more relevant to the search context, and consequently, may be rendered for the map using a rendering style that distinguishes the feature from the other rendered map features, as will be described in further detail below.

In an embodiment, prominence ranker 220 determines the relevance of a particular map feature to the search context, and thus, the appropriate prominence score or ranking for the map feature, by analyzing the request from the user and one or more attributes or signals related to the user's request. For example, a given search context may be associated with the specific user who initiated request for a view of the map or a search request for one or more point(s) of interest or directions to a particular geographic location/point of interest, as described above.

In an embodiment, prominence ranker 220 may determine the relevance of each map feature based one or more attributes associated with the search context in relation to the user. For example, such attributes may include, but are not limited to, one or more search terms that were input by the user (e.g., at client 110), the geographic location of the user, the user's search history (e.g., previously entered search terms or prior search context history), and the time of day when the search was initiated by the user. Additional attributes or sources of information that prominence ranker 220 may use to calculate prominence scores for map features may include the potential constraints associated with the client device of the user (e.g., client 110). For example, the type of device (e.g., mobile vs. desktop client, high bandwidth vs. low, large display vs. small) and its performance characteristics (e.g., processing power, memory constraints, etc.) may be relevant to the calculation of prominence scores. In an example, prominence ranker 220 may use, at least in part, the device type and characteristics to determine a threshold between the map features that should have relatively higher prominence scores and those that should not (e.g., a landmark worth showing in higher detail, and those that are not). Further, ranking data associated with a point of interest or a geographic area of interest from the user or other third-party users or content providers may be another source of information that can be used for assigning prominence scores to map features based on a search context for the user.

In an example, a placemark corresponding to a map feature may be associated with ranking data or other descriptive information. For example, ranking information, which may be referred to as “place rank,” may be directly or indirectly provided by the user, or alternatively, by one or more third-party users or content providers. For example, relative place rank may be calculated a geographic point of interest or placemark on the map by a map server system (e.g., by server(s) 150) based on information from multiple third-parties. Such a relative place rank associated with a map feature may be used by prominence ranker 220 to determine if the map feature is a landmark, and thus, should be assigned a relatively higher prominence score. For example, a map feature that is determined to be a particular landmark based on a relative place rank associated with the map feature may be assigned such a relatively high prominence score that the feature gets rendered as a photorealistic representation on the map when it is displayed for the user. Additional features and characteristics associated with relative place ranks associated with placemarks and map features as described herein would be apparent to a person skilled in the relevant art.

In another embodiment, ranking data comprises various indications of a user's interest in certain placemarks. For instance, placemarks that have been saved or annotated by the user at the browser or application level could be deemed to be of greater interest to a user. A user's search terms or patterns of web page access or use may also be correlated to certain geospatial entities and used by an prominence ranker 220 at the client (e.g., client 110 of FIG. 1, described above) or on a server (e.g., server(s) 150 of FIG. 1) to select placemarks for the user. In addition, placemarks that the user has defined for his/her own use may be assumed to be of high personal interest.

In one such embodiment, geospatial entities including points of interest or personal relevance to the user, such as the location of the user's house, workplace, child's daycare, or favorite playground are identified and marked on any map in the vicinity of these elements, regardless of their relative rank as calculated by prominence ranker 220. These and other indications of user interest may be gauged from the user's behavior, the time of day, or may be in the form of preferences or instructions regarding entities affirmatively provided by the user, for instance, instructing the inclusion or exclusion of specific entities or groups of entities in maps provided by a map server system. A rankings premium may be assigned to geospatial entities based on the user's interest or preferences. For example, user data collected at client 110 may be stored in a memory of context analyzer 210 and used by prominence ranker 220 to generate prominence rankings for map features that are personal to the user.

In an embodiment, prominence ranker 220 automatically calculates a total prominence score for a set of map features in a geographic area of interest based on these various sources of information or search attributes that can be associated with a given search context. For further illustration, the exemplary attributes listed above (e.g., geographic location of the user, user's search history, time of day, and ranking data associated with a map feature) will be described in the context of the aforementioned example of route navigation using turn-by-turn directions. However, it would be apparent to a person skilled in the relevant art given this description that embodiments are not intended to be limited thereto.

In an example, a current geographic location of the user and the user's search history may be used to determine whether the user's current location corresponds to a new geographic area of the map or an area often visited by the user (e.g., areas along the user's daily commute to work). For example, it may be determined (e.g., by context analyzer 210) that a current route of travel is new or outside the user's usual travel routes based on current location data for the user, the user's prior travel patterns, and the current time of day. Consequently, it may be assumed that the user is located in an unfamiliar area, and therefore, may require additional guidance. Accordingly, certain map features may be ranked higher and displayed more prominently so as to provide additional navigational information that may be helpful to the user as the user travels along a recommended route to the destination. For example, selected map features corresponding to buildings or other landmarks located at street corners at which the user would need to turn in accordance with the recommended route of travel (e.g., visualized as a map overlay comprising a highlighted path) may be rendered more prominently relative to other features along the route.

In an embodiment, feature generator 230 is configured to generate a graphical representation or model 232 for each map feature in the plurality of map features to be rendered in association with a geographic region of interest on a map. In an example, the generated map feature representation/model 232 may be based on the respective prominence scores or rankings assigned by prominence ranker 220, as described above. Further, feature model 232 may be a model of the map feature to be rendered (e.g., at client 110 of FIG. 1, as described above) according to a particular rendering style selected from various different rendering styles. As previously discussed, examples of different rendering styles that may be associated with varying levels of detail include, but are not limited to, two-dimensional (2D) footprints (e.g., of building structures), two-and-a-half-dimensional (2.5D) extruded polygons, as previously described, and full three-dimensional (3D) and or photorealistic models or representations. Furthermore, such rendering styles may include, but are not limited to, rendering scale, different color options and visual textures. For example, such colors or visual textures may be added to representation of various map features using one or more visual overlays corresponding to the appropriate map feature(s) on the map as displayed to the user.

In an embodiment, the graphical representation of the map feature generated by feature generator 230 may include a designated rendering style based on the feature's prominence score/ranking relative to those of the other map features to be rendered for a geographic area of interest. In an embodiment, the generated graphical representations of such map features will be rendered (e.g., on a display at client 110) in accordance with a rendering style that enables these features to be distinguishable from the other features on the map, as noted above. In an example, a map feature assigned a relatively higher prominence score may be rendered at a relatively higher level of detail (e.g., in full 3D or as photorealistic representation) than other map features, which may be rendered, for example, as 2D footprints.

As described previously, a 2.5D representation of a map feature comprises a set of extruded polygons (e.g., right prisms). Also as described above, each extruded polygon in the set can have multiple shells (e.g., outer loops) and holes (e.g., inner loops). Further, the volume in space of each extruded polygon can be defined by a base height from which extrusion begins, and an extrusion distance associated with the representation of the object in space. Additional details of such a 2.5D representation or model would be apparent to a person skilled in the relevant art given this description.

In an embodiment, feature generator 230 generates a feature model 232 according to a particular level of detail associated with a rendering style, as described above. For example, feature model 232 may be a 2D, 2.5D, or 3D model comprising a plurality of polygons. In a further embodiment, feature generator 230 may be configured to automatically generate 2D or 2.5D representations of the map features based on a full 3D model. For example, feature generator 230 may generate simplified versions of a full 3D model of a map feature (e.g., a building).

Further, different versions of the generated graphical representation or map feature model 232 can be stored in a memory or storage at varying levels of detail for later access. Referring back to FIG. 1, for example, database 170 may be one or more specialized databases or repositories for storing graphical representations/models of various map features, as described above. For example, database 170 may be a standalone database communicatively coupled to feature generator 230 or server(s) 150 via network 140. Alternatively, database 170 may be any type of storage medium for storing data, including computer-generated graphical models accessible to feature generator 230.

In an embodiment, feature generator 230 assigns the generated graphical representation(s) of a map feature (i.e., feature model 232) to a resolution level of a geospatial data structure such as a quad tree. For example, a particular resolution level may be selected from a plurality of resolution levels of such a quad tree data structure. The quad tree also may have various nodes corresponding to various resolution levels or levels of detail. Further, each node of the quad tree may correspond to a different zoom level for viewing the map feature being represented. Additional characteristics regarding the use and operation of such a geospatial quad tree data structure for the access and storage of graphical representations or models would be apparent to a person skilled in the relevant art given this description.

### Example Browser Displays

FIGS. 3A and 3B illustrate example browser displays 300A and 300B, respectively, for a web-based mapping service such as mapping service 130 and an integrated map image viewer such as image viewer 120 of FIG. 1, as described above, according to an embodiment. In the example shown in FIG. 3A, the mapping service provides various user interface elements 320 that, when selected, preferably changes the orientation and appearance of the map in areas where map data is available. For example, streets with available map data may be highlighted, for example, as depicted by arrow 315 in example display 300B. This highlighting can be, for example, a colored and/or shaded outline or overlay, or a change in color and/or shading. This can be implemented by using a transparency image with a map tile or by directly including the effect in the map tile served to the mapping service (e.g., via map tiles 132 of FIG. 1, as described above).

As would be apparent to a person skilled in the relevant art given this description, the prominence ranking techniques described herein can be used in combination with any conventional, proprietary, and/or emerging techniques to generate a digital map. In the case of a conventional raster map, for instance, placemarks and other types of map data may be used to create a map in a digital format such as .jpeg, .gif, or .png, at a map server (e.g., server(s) 150 of FIG. 1, described above) and then delivered to a client (e.g., client 110 of FIG. 1). User requests to manipulate or interact with the map, are provided from the client to the server, which in turn generates the requested map view, as illustrated in the example viewports 310A and 310B of FIGS. 3A and 3B, respectively. For example, a user may input one or more search terms via search field 330 of browser display 300A. As shown by the example searches in display 300A of FIG. 3A, search terms input by the user may include, but are not limited to, a business name, a physical address of a point of interest, and a request for directions between different points of interest.

In an embodiment, the map server serves portions of a tiled raster map, in which pre-generated, rasterized images or “tiles” (e.g., map tiles 132 of FIG. 1) that include map feature data are stored at a map server. For example, when the user submits a map query, the rasterized images may be provided to the client, where they are used to create a view of the requested map or geographic region of interest. Additional views based on, for instance, panning, zooming, or tilting the requested map can be generated at the client using the tiles. Vector-based methods can also be used to generate digital maps in accordance with other embodiments.

In one example, map data, including feature data, is provided to the client by a map server in the form of vector graphic instructions. The instructions are interpreted by an application at the client in real-time to generate a map for the user. As a user interacts with the map, for instance, by including or excluding various layers including representations of geospatial features of the map, the map can be dynamically updated at the client to include those layers. Likewise, as the user interacts with the map, for instance, by zooming or panning, the map can be dynamically regenerated at the client to include the new map views. For example, the prominence and landmark-threshold calculations may be performed locally at the client (e.g., at a mobile device of the user). Further, the server may provide both high-quality and low-quality vector graphic instructions for any particular set of features as may be necessary. Additionally, the client device may “pre-fetch” map data from the server for subsequent processing and rendering of the pre-fetched map to a display (e.g., touchscreen display). This kind of functionality may be especially important for performance reasons if, for example, the device is operating in an offline or low-bandwidth mode during times of limited or no network connectivity.

In a further example, the image viewer may be instantiated by the mapping service and presented in the form of viewport 310A that is embedded in a web browser, as illustrated in FIG. 3A. The orientation of the visual representation of the map within viewport 310A matches the orientation of a virtual camera, as specified by the user via user interface controls or elements 320. As the user manipulates the visual representation of the map within viewport 310A, the image viewer informs the mapping service of any changes in orientation or location so that the mapping service can update the orientation and location of the visual representation of the map and any map features being displayed within viewport 310A.

In an embodiment, viewport 310A of the map image viewer presents a panoramic image of the selected area. The user can click and drag around on the image to look around 360 degrees. In the example viewport 310A depicted in FIG. 3A, a variety of user interface elements 320 are added to the underlying map image. These elements include navigation inputs such as, for example, zoom and panning controls (e.g., navigation buttons) on the left side of the viewport and annotations in the form of lines/bars, arrows, placemarks, and text that are provided directly in the panorama itself. The annotations are rendered in an appropriate manner that roughly matches the scene depicted in the viewport.

In a different embodiment, as shown in FIG. 3B, for example, each street may be selectable by a user (by clicking or by dragging along the street line), and an arrow 315 may be displayed corresponding to a direction of movement. Arrow 315 in viewport 310B corresponds to the street depicted in the corresponding map image and can even be rendered in a different color as the streets depicted in the map. In an embodiment, viewport 310B allows the user to navigate up and down the street (i.e., to change the vantage point from which the street is viewed). As the user looks around 360 degrees, the lines and arrows smoothly track the underlying imagery so that the lines remain on top of the underlying streets, and so that the arrows are always visible on the screen. This allows the user to navigate along the street while looking straight ahead, as shown in example display 300B of FIG. 3B. As such, the mapping service and image viewer may be configured to function, for example, as a navigation application in a GPS navigation system.

For instance, when the user selects an arrow to navigate within the viewport (e.g., using an input device such as a mouse), a zooming cross-fade effect and other visual cues may be used to give the user a sense of movement. When the user arrives at an intersection of two streets, there is one green line and two arrows for each street. All of these are visible at the same time, and all are labeled, so that the user knows the current location and can proceed in any direction. This technique can readily scale to accommodate complex intersections with more than four directions. When the user reaches a “dead end” where the road continues but no further imagery is available, there is only one arrow on the street indicating the direction in which the user can navigate. In the other direction, a symbolic icon or message embedded in the image can be presented appropriately to inform the user that imagery is not available in this direction.

The user interface is not restricted to navigating along a line to walk down a street and can be readily extended to allow users to stray from the line elements when useful: for example, to cross over to the opposite side of the street to get a closer look at something. Moreover, there may be environments within a geographic area/region of interest, for example, corresponding to a city, where a user might be expected to desire to snap off of a particular view of a street and navigate freely within an adjacent area, for example, a park, plaza, shopping area, or other public place. The interface can be readily enhanced with “free movement zones” to provide this functionality.

It is also noted that the user interface may be presented in the context of navigation between different views of map features at varying levels of details and/or levels of zoom, where such features may be represented in graphical form, as discrete street-level panoramic images, or a continuous set of panoramic data. Further, a user may be able to navigate through such representations along a street or aerial view such that the user would be presented with a visually smooth experience similar to viewing, for example, the playback of scenes in a video.

### Method

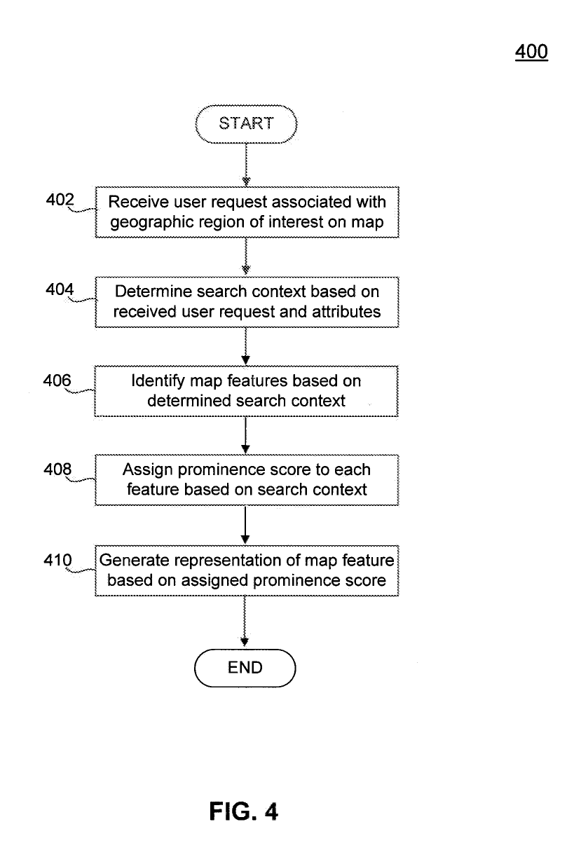

FIG. 4 is a process flowchart of an exemplary method 400 for prominence-based generation of map features, according to an embodiment. For ease of explanation, system 100 of FIG. 1, as described above, will be used to describe method 400, but is not intended to be limited thereto. Further, for ease of explanation, method 400 will be described in the context of system 200 of FIG. 2, as described above, but is not intended to be limited thereto. Based on the description herein, a person of ordinary skill in the relevant art will recognize that method 400 can be executed on any type of computing device (e.g., client 110 or server(s) 150 of FIG. 1).

Method 400 begins in step 402, which includes receiving a user request associated with a geographic area or region of interest on a map. For example, such a user request may be for a general view of the map (e.g., at a particular level of zoom), one or more specific points of interest on the map, or travel directions between different points of interest on the map, as previously described. In step 404, the appropriate search context is determined based on the received user request and one or more attributes associated with the user request or search context including, but not limited to, geographic location of the user, user's search history, time of day, and ranking data associated with a map feature, as described above. Steps 402 and 404 may be performed by, for example, context analyzer 210 in system 200 of FIG. 2, as described above.

Method 400 then proceeds to step 406 in which various map features are appropriately identified or selected for display to the user (e.g., via a display communicatively coupled to client 110) based on the search context as determined in step 404. For example, the map features to be rendered or displayed may be based on one or more search terms input by the user and the current geographic location of the user, the user's search history or previous travel patterns, the current time of day when the request was initiated, and other ranking data associated with particular map features, as described above.

Once the relevant map feature(s) have been identified, method 400 proceeds to step 408, in which each of the identified map features are assigned a prominence score or ranking based on the relevance or relative significance of each map feature with respect to the search context. In step 410, a graphical representation of each of the map features is generated based on the feature's assigned prominence score. As described above, map features may be rendered on the map in accordance with various rendering styles, where the rendering style for each map feature is based on the relative prominence score assigned to the map feature. The generated representation of the map feature(s) may be stored in memory for later access and display to a user, as described above. Although not shown in FIG. 4, method 400 may include the additional step of rendering or displaying the generated representation. For example, the graphical representation may be rendered in an image viewer of a mapping service (e.g., image viewer 120 of mapping service 130 in system 100 of FIG. 1, as described above), which is displayed to a user via a display coupled to a client device (e.g., client 110 in system 100, as described above).

In an example, the user may search for driving directions to a particular physical address of a business or residence. In addition to turn-by-turn driving directions, a highlighted route to the destination may be displayed, for example, as an overlay on the map. To further assist the user in navigating to the destination, buildings where the user needs to turn and various points of interest (e.g., landmarks) located along the route can be rendered more prominently than other non-prominent features, which represent features on the map that may not be of significant interest to the user.

Method 400 can be implemented solely on a client device or on one or more server devices such as, for example, client 110 or server(s) 150 in system 100 of FIG. 1, as described above. Also, as described above, a client device (e.g., a mobile device) may pre-fetch map data from a server for later processing (e.g., performing steps of method 400) and rendering of the map and map features to a display (e.g., a touchscreen display). This may be especially important for performance reasons if, for example, the device is operating in an offline or low-bandwidth mode during times of limited or no network connectivity. One benefit of using method 400 includes enabling users to distinguish particular map features that may be more pertinent to their individual needs and search criteria than other map features. For example, such map features may correspond to a geographic region of interest or one or more specific points of interest to be represented on a digital map, as described above.

### Example Computer System Implementation

Embodiments shown in FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

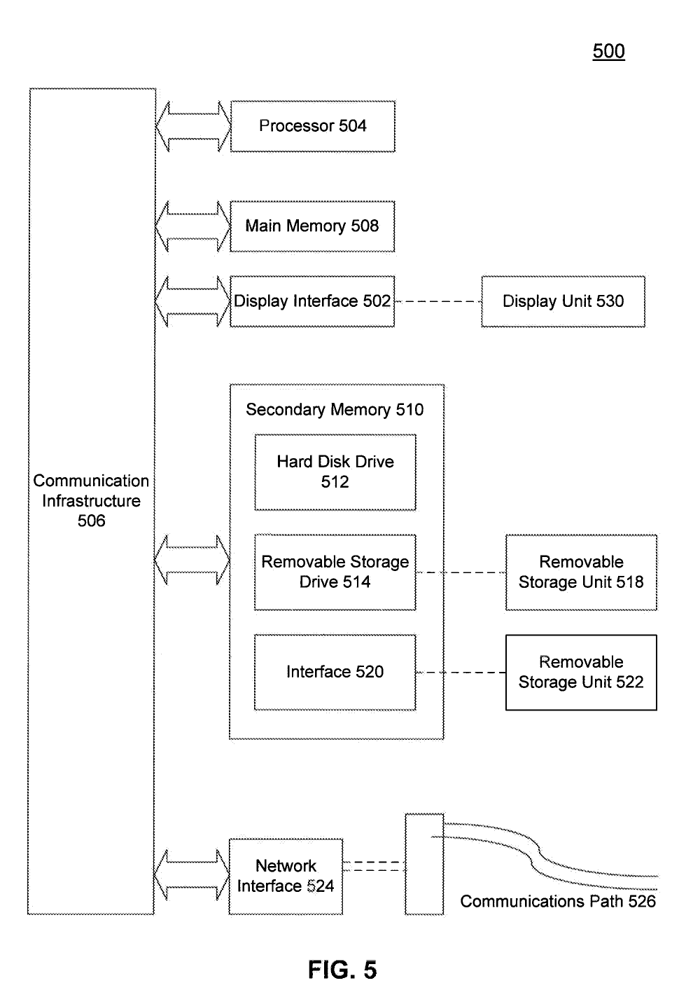

FIG. 5 illustrates an example computer system 500 in which embodiments, or portions thereof, may be implemented as computer-readable code. For example, context analyzer 210, prominence ranker 220, and feature generator 230 of FIG. 2, described above, can be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-4.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computer linked or clustered with distributed functions, and any pervasive or miniature computer that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. As will be appreciated by persons skilled in the relevant art, processor device 504 may also be a single processor in a multi-core/multiprocessor system, such system operating alone, or in a cluster of computing devices operating in a cluster or server farm. Processor device 504 is connected to a communication infrastructure 506, for example, a bus, message queue, network, or multi-core message-passing scheme.

Computer system 500 also includes a main memory 508, for example, random access memory (RAM), and may also include a secondary memory 510. Secondary memory 510 may include, for example, a hard disk drive 512, removable storage drive 514. Removable storage drive 514 may comprise a floppy disk drive, a magnetic tape drive, an optical disk drive, a flash memory, or the like. The removable storage drive 514 reads from and/or writes to a removable storage unit 518 in a well-known manner. Removable storage unit 518 may comprise a floppy disk, magnetic tape, optical disk, etc. which is read by and written to by removable storage drive 514. As will be appreciated by persons skilled in the relevant art, removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM, and associated socket, and other removable storage units 522 and interfaces 520 which allow software and data to be transferred from the removable storage unit 522 to computer system 500.

Computer system 500 may also include a communications network interface 524. Network interface 524 allows software and data to be transferred between computer system 500 and external devices. Network interface 524 may include a modem, a network interface (such as an Ethernet card), a communications port, a PCMCIA slot and card, or the like. Software and data transferred via network interface 524 may be in the form of signals, which may be electronic, electromagnetic, optical, or other signals capable of being received by network interface 524. These signals may be provided to network interface 524 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 512. Computer program medium and computer usable medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via network interface 524. Such computer programs, when executed, enable computer system 500 to implement the present invention as discussed herein. In particular, the computer programs, when executed, enable processor device 504 to implement the processes of embodiments of the present invention, such as the stages in the method illustrated by flowchart 400 of FIG. 4, discussed above. Accordingly, such computer programs represent controllers of the computer system 500. Where embodiments of the invention are implemented using software, the software may be stored in a computer program product and loaded into computer system 500 using removable storage drive 514, interface 520, hard disk drive 512, or network interface 524.

Embodiments also may be directed to computer program products comprising software stored on any computer useable medium. Such software, when executed in one or more data processing device, causes a data processing device(s) to operate as described herein. Embodiments may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

### CONCLUSION

The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for prominence-based generation and rendering of map features, comprising:
determining a search context for a user of a map based on user input, the search context corresponding to a geographic region of interest on the map, the geographic region of interest having a plurality of map features;
assigning a prominence score to each map feature in the plurality of map features based on the determined search context for the user, the prominence score of each map feature representing the map feature's relevance with respect to the search context;
generating a graphical representation of each map feature in the plurality of map features based on the assigned prominence score, the graphical representation to be rendered in association with the geographic region of interest on the map in accordance with a rendering style selected from a plurality of rendering styles, wherein the selected rendering style is based on the respective prominence score assigned to each of the map features; and
storing, in a memory, the generated graphical representation of each of the respective map features associated with the geographic region of interest on the map,
wherein the determining, the assigning, the generating, and the storing are performed by one or more computing devices.

2. The method of claim 1, wherein the assigning comprises:
calculating the prominence score for each map feature in the plurality of map features based on the determined search context; and
associating the calculated prominence score with each map feature in the plurality of map features.

3. The method of claim 1, wherein map features in the plurality of map features having relatively higher prominence scores are to be rendered on the map at relatively higher levels of detail.

4. The method of claim 1, wherein the determining comprises:
determining a current view of the map to be displayed to the user based on the user input, wherein the current view specifies the geographic region of interest on the map.

5. The method of claim 1, wherein the determining comprises:
determining a path between a current geographic location associated with the user and a destination on the map in response to the user input, the user input including a request from the user for directions to the destination; and
performing a search for geographic points of interest on the map based on the determined path, wherein the geographic points of interest are associated with one or more map features in the plurality of map features, and the one or more map features are located along the path, and
wherein each of the one or more map features is to be rendered on the map at a higher level of detail relative to any other map features in the plurality of map features.

6. The method of claim 1, wherein the determining comprises:
performing a search for a geographic point of interest on the map for a user based on one or more search terms input by the user, wherein the geographic point of interest is associated with a first set of features in the plurality of map features; and
determining the search context based on the performed search and one or more search attributes associated with the user, wherein the one or more search attributes are used to further define which map features are included in the first set of features associated with the geographic point of interest.

7. The method of claim 6, wherein the one or more search attributes associated with the user include at least one of a current geographic location associated with the user, a search history of prior search terms input by the user, and a current time of day of the user input.

8. The method of claim 6, wherein the assigning comprises:
assigning a first prominence score to each map feature in the first set of features associated with the geographic point of interest; and
assigning a second prominence score to each map feature in a second set of features in the plurality of map features, wherein the second set of features is not associated with the geographic point of interest, the second set of features includes any map features in the plurality of map features not included in the first set of features, and the first prominence score is higher than the second prominence score.

9. The method of claim 8, wherein each map feature in the first and second sets of features is rendered on the map based on the respective first and second prominence scores, and the first set of features is rendered on the map at a higher level of detail than the second set of features.

10. The method of claim 1, wherein the plurality of rendering styles includes a two-dimensional representation, a two-and-a-half-dimensional representation, and a full three-dimensional representation.

11. The method of claim 10, wherein the plurality of rendering styles further includes one or more of a color, a visual texture, and a rendering scale.

12. A system for prominence-based generation and rendering of map features, comprising:
one or more processors;
a context analyzer to determine a search context for a user of a map based on user input, the search context corresponding to a geographic region of interest on the map, the geographic region of interest having a plurality of map features;
a prominence ranker to assign a prominence score to each map feature in the plurality of map features based on the determined search context for the user, the prominence score of each map feature representing the map feature's relevance with respect to the search context;
a feature generator to generate a graphical representation of each map feature in the plurality of map features based on the assigned prominence score, the graphical representation to be rendered in association with the geographic region of interest on the map in accordance with a rendering style selected from a plurality of rendering styles, wherein the selected rendering style is based on the respective prominence score assigned to each of the map features; and
a memory to store the generated graphical representation of each of the respective map features associated with the geographic region of interest on the map,
wherein the context analyzer, the prominence ranker, and the feature generator are implemented using the one or more processors.

13. The system of claim 12, wherein the prominence ranker is configured to calculate the prominence score for each map feature in the plurality of map features based on the determined search context, and to associate the calculated prominence score with each map feature in the plurality of map features.

14. The system of claim 12, wherein map features in the plurality of map features having relatively higher prominence scores are to be rendered on the map at relatively higher levels of detail.

15. The system of claim 12, wherein the context analyzer is configured to determine a current view of the map to be displayed to the user based on the user input, wherein the current view specifies the geographic region of interest on the map.

16. The system of claim 12, wherein the context analyzer is configured to determine a path between a current geographic location associated with the user and a destination on the map in response to the user input, the user input including a request from the user for directions to the destination, and to perform a search for geographic points of interest on the map based on the determined path, wherein the geographic points of interest are associated with one or more map features in the plurality of map features, the one or more map features are located along the path, and each of the one or more map features is to be rendered on the map at a higher level of detail relative to any other map features in the plurality of map features.

17. The system of claim 12, wherein the context analyzer is configured to perform a search for a geographic point of interest on the map for a user based on one or more search terms input by the user, wherein the geographic point of interest is associated with a first set of features in the plurality of map features, and to determine the search context based on the performed search and one or more search attributes associated with the user, wherein the one or more search attributes are used to further define which map features are included in the first set of features associated with the geographic point of interest.

18. The system of claim 17, wherein the one or more search attributes associated with the user include at least one of a current geographic location associated with the user, a search history of prior search terms input by the user, and a current time of day of the user input.

19. The system of claim 17, wherein the prominence ranker is configured to assign a first prominence score to each map feature in the first set of features associated with the geographic point of interest, and to assign a second prominence score to each map feature in a second set of features in the plurality of map features, wherein the second set of features is not associated with the geographic point of interest, the second set of features includes any map features in the plurality of map features not included in the first set of features, and the first prominence score is higher than the second prominence score.

20. The system of claim 19, wherein each map feature in the first and second sets of features is to be rendered on the map based on the respective first and second prominence scores, and the first set of features will be rendered on the map at a higher level of detail than the second set of features.

21. The system of claim 12, wherein the plurality of rendering styles includes a two-dimensional representation, a two-and-a-half-dimensional representation, and a full three-dimensional representation.

22. The system of claim 21, wherein the plurality of rendering styles further includes one or more of a color, a visual texture, and a rendering scale.
